(19) United States
(12) Patent Application Publication
(10) Pub. No.: US 2003/0136094 A1
(43) Pub. Date: Jul. 24, 2003

(54) Axial flow centrifugal dust separator

(76) Inventors: Lewis Illingworth, Kensington, NH (US); David Reinfeld, Englewood, NJ (US)

Correspondence Address: Ward & Olivo, Suite 300, 382 Springfield Avenue, Summit, NJ, 07901, US

(21) Appl. No.: 10/318,320

(22) Filed: Dec. 12, 2002

Related U.S. Application Data
(63) Continuation-in-part of application No. 10/025,376, filed on Dec. 19, 2001.
Application No. 10/025,376 is a continuation-in-part of application No. 09/835,084, filed on Apr. 13, 2001.
Application No. 09/835,084 is a continuation-in-part of application No. 09/829,416, filed on Apr. 9, 2001.
Application No. 09/829,416 is a continuation-in-part of application No. 09/728,602, filed on Dec. 1, 2000.
Application No. 09/728,602 is a continuation-in-part of application No. 09/316,318, filed on May 21, 1999.

(51) Int. Cl. B01D 45/14

(52) U.S. Cl. 55/406; 95/270

(57) ABSTRACT

Disclosed is an improved vacuum cleaning apparatus utilizing a self-sustained vortex flow in a centrifugal separator. More specifically, vortex flow is maintained via pressure differentials allowing the ejection of dust and other particles without bags, filters, or liquid baths. Furthermore, the impeller inside of the separator serves the dual purpose of moving fluid through the system as well as creating a cylindrical vortex fluid flow. Additional circulating blades present throughout the separation chamber prevent fluid flow from slowing due to frictional losses. The axial design of the present invention allows the centrifugal separator to be constructed with an arbitrary length. The present invention excels in producing clean fluid of a better quality more efficiently, more quietly, and more simply than devices known in the art.

### CROSS REFERENCE TO OTHER APPLICATIONS

This application is filed as a continuation-in-part of co-pending application Ser. No. 10/025,376 entitled “Toroidal Vortex Vacuum Cleaner Centrifugal Dust Separator,” filed Dec. 19, 2001, which is a continuation-in-part of co-pending application Ser. No. 09/835,084 entitled “Toroidal Vortex Bagless Vacuum Cleaner,” filed Apr. 13, 2001, which is a continuation-in-part of co-pending application Ser. No. 09/829,416 entitled “Toroidal and Compound Vortex Attractor,” filed Apr. 9, 2001, which is a continuation-in-part of co-pending application Ser. No. 09/728,602, filed Dec. 1, 2000, entitled “Lifting Platform,” which is a continuation-in-part of co-pending Ser. No. 09/316,318, filed May 21, 1999, entitled “Vortex Attractor.”

### TECHNICAL FIELD OF THE INVENTION

The present invention relates to an improved centrifugal dust separator. Specifically, the improved dust separator centrifugally separates dust by ejecting particles into a collector attached to the side of a separation chamber. The high pressure within the collector maintains the cylindrical fluid flow within the separator. Circulating blades are implemented to compensate for energy losses due to friction. The fluid inlet is at the opposite side of the fluid outlet to adapt the separator for general use.

### BACKGROUND OF THE INVENTION

Centrifugal separation is a well known technique in the art of separation, including separation of solids from liquids, liquids from gases, and liquids from liquids. Although the present invention is unique and novel, in order to fully understand it in its proper context, the following references are provided.

Specifically, the references of Dyson, U.S. Pat. No. 4,593,429, Kasper et al., U.S. Pat. No. 5,030,257, Moredock, U.S. Pat. No. 5,766,315, Tuvin et al., U.S. Pat. No. 6,168,641, and Song et al., U.S. Pat. No. 6,195,835, are relevant to the present invention.

Dyson, U.S. Pat. No. 4,593,429, discloses a vacuum cleaning appliance utilizing a series of connected cyclones. The appliance utilizes a low-efficiency cyclone in series with a high-efficiency cyclone. This is done in order to effectively collect both large and small particles, respectively. Dyson teaches the incorporation of a low-efficiency cyclone to handle larger particles. Small particles continue to be handled by the high-efficiency cyclone. While both Dyson and the present invention utilize a bagless configuration, they utilize completely different flow technology. Unlike Dyson, the flow geometry of the present invention allows separation of both large and small particles by a single separation process.

Kasper et al., U.S. Pat. No. 5,030,257, makes use of a vortex contained in a vertically aligned cylinder comprising multiple slots running the length of the side of the cylinder. A vortex fluid flow is generated within the cylinder, thereby ejecting air, dirt, and other unwanted debris outward through the slots. The ejected air and debris then come into contact with the surface of a liquid bath. The liquid then captures the debris and the clean air is free to return to the inside of the cylinder.

Kasper et al. requires a liquid bath, and this is a major difference between Kasper et al. and the present invention. Liquid baths add both weight and complexity to the vacuum cleaner system. Furthermore, the liquid must be periodically changed to prevent corrosion, etc. Another feature of Kasper et al. is the mixing of circulating air ejected from the cyclone with non-circulating incoming air. To maximize efficiency and simplicity, a separator preferably requires no liquid bath and does not mix circulating and non-circulating air.

Accordingly, the present invention is designed for maximal efficiency and simplicity. First, the present invention does not utilize a liquid bath or a liquid-air surface to separate debris from fluid; in fact, one feature of the present invention is its ability to separate matter from liquids as well as gases. Kasper et al.'s device does not achieve such results given the necessity of the liquid-air surface for collecting particles. Second, the present invention uses a solid surface to maintain cylindrical flow in conjunction with high pressure in the dust collector. No such pressure is provided in Kasper et al.'s patent; air is free to be ejected out the slots and return into the cylinder from beneath. Moreover, the present invention avoids mixing non-rotating incoming fluid with already circulating air by ensuring that all incoming air is traveling in a circular path.

Moredock, U.S. Pat. No. 5,766,315, discloses a centrifugal separator that ejects particles radially. In order to create a cyclone, Moredock directs the air entering the cyclone chamber tangentially with the chamber's wall. Therefore, the chamber's wall forces the air into the cyclone flow pattern. Additionally, the speed of airflow in the cyclone is that of the incoming flow. Further, Moredock ejects particles from the dome via a slot running vertically along the wall. The slot leads into a duct traveling away from the apparatus. Thus, the duct allows air to exit along with the particles.

The aforementioned aspects of Moredock are not found in the present invention. For instance, the present invention utilizes an impeller or centrifugal pump to create the cylindrical flow and the necessary suction in a single step. This has energy and efficiency advantages over Moredock's configuration. Further, incoming fluid is spun at the blade speed of the impeller, and consequently, can achieve a higher rate of rotation than that which is possible with Moredock's configuration. Also, the present invention uses back-pressure from the dust collector to maintain a cylindrical vortex. Moredock, on the other hand, expels air from the system. However, the present invention keeps the dust-laden air within the system to prevent dust from escaping into the atmosphere; fluid does not exit until it has been sufficiently cleaned. Therefore, the present invention advances over Moredock.

Tuvin et al., U.S. Pat. No. 6,168,641, also makes use of a cyclone separation system. Tuvin et al.'s patent includes a cyclone separator that ejects particles outward from a cyclone. As in Moredock, Tuvin et al. creates the cylindrical flow by allowing air to enter the dome tangentially with respect to the wall. Further, Tuvin et al. makes use of a filter as the final step before air exits the device. Also, Tuvin et al.'s invention necessitates two separation steps, involving a course separator and a cyclone chamber. Therefore, the cyclone chamber separates fine particles while the course separator is employed for larger particles. However, the present invention is designed to provide a simpler design than Tuvin et al.

First, the present invention provides both suction and the cylindrical vortex fluid flow with a single impeller. Thus, the separate suction means and directing means utilized in Tuvin et al. are unnecessary. Moreover, incoming fluid is spun at the blade speed of the impeller in the present invention. Such high rotational speed is not found in Tuvin et al. Also, filters are not used in the present invention because separation is sufficiently performed without them. Finally, the present invention separates all matter in a single separation chamber, unlike the two separation steps of Tuvin et al. Consequently, the present invention is simpler and more efficient than that which is disclosed in Tuvin et al.

Song et al., U.S. Pat. No. 6,195,835, is directed to a vacuum cleaner having a cyclone dust collecting device for separating and collecting dust and dirt of a large particle size. The cyclone dust collecting device is biaxially placed against the extension pipe of the cleaner and includes a cyclone body having two tubes connected to the extension pipe and a dirt collecting tub connected to the cyclone body.

Specifically, the dirt collecting tub of Song et al. is removable. The cyclone body has an air inlet and an air outlet. The dirt-containing air sucked via the suction opening enters via the air inlet in a slanting direction against the cyclone body, thereby producing a whirlpool air current inside of the cyclone body. The dirt is separated from the air centrifugally and is collected in the dirt collecting tub. A dirt separating grill having multiple holes is formed at the air outlet of the cyclone body to prevent the dust from flowing backward via the air outlet together with the air. Thus, the dirt sucked in by the device is primarily collected by the cyclone dust collecting device, thus extending the period of time before which the paper filter must be replaced. However, the present invention is configured to advance over Song et al.

The device of Song et al. differs primarily from the present invention in that Song et al. utilizes a filter. The present invention utilizes such an efficient flow geometry that the need for a filter is eliminated.

Thus, there is a clear need for a simple, light weight, efficient, quiet, and filterless centrifugal separator. The art is devoid of such a device, but the present invention meets these needs.

### SUMMARY OF THE INVENTION

The present invention relies upon technology from Applicant's prior invention disclosed in co-pending application Ser. No. 10/025,376 entitled “Toroidal Vortex Bagless Vacuum Cleaner Centrifugal Dust Separator,” filed Dec. 19, 2001, which is incorporated herein by reference. The separator of this application is based on technology disclosed in co-pending application Ser. No. 09/835,084 entitled “Toroidal Vortex Bagless Vacuum Cleaner,” filed Apr. 13, 2001, which is incorporated herein by reference. The bagless vacuum cleaner of this invention was developed from technology disclosed in the co-pending application Ser. No. 09/829,416 entitled “Toroidal and Compound Vortex Attractor,” filed Apr. 9, 2001, which is incorporated herein by reference. These attractors stem from technology disclosed in the co-pending application Ser. No. 09/728,602 entitled “Lifting Platform,” filed on Dec. 1, 2000, which is incorporated herein by reference. Finally, the lifting platform technology is based upon technology disclosed in co-pending application Ser. No. 09/316,318 entitled “Vortex Attractor,” filed May 21, 1999, which is incorporated herein by reference.

As indicated above, the present invention was developed from the centrifugal separators of parent applications. Therein, cylindrical vortices are formed such that a circular pattern of flow exiting from the impeller spirals along the chamber's outer wall. The circular flow of the fluid acts as a centrifuge, forcing the higher mass dust particles outward. The spiraling fluid also creates a pressure in the dust collector greater than the pressure in the separation chamber due to the kinetic energy of the circulating fluid. This high pressure pushes the spiraling fluid inward, maintaining the fluid's circular path. However, the dust particles are not inhibited from traveling straight into the collector.

Unlike other vacuum cleaners that employ centrifugal dust separation (e.g., the “cyclone” types discussed previously), the centrifugal separator disclosed herein spins the fluid around at the blade speed of the impeller. Thus, the system acts like a high speed centrifuge capable of removing very small particles from the fluid flow. No vacuum bag, liquid bath, or filter is required.

One of the main features of the present centrifugal dust separator is the inherent low power consumption. The energy losses that occur when bags or filters are utilized are not present here. Specifically, bags and filters resist fluid flow, thus requiring greater power to maintain a given flowrate. Additionally, since only smooth changes in the direction of fluid flow are made in the present invention, the effect on the energy of the moving fluid is minimal. Hence, the present centrifugal separator contains provisions not already considered in the art. Furthermore, the design is expected to be virtually maintenance free.

In the centrifugal separators, fluid flow is slowed by frictional losses when circulating along the separation chamber's walls. Consequently, Applicant's previous design has been modified to compensate for such frictional losses, thereby more completely cleaning incoming fluid. Particularly, the separator is modified with the addition of circulating blades that run the length of the separation chamber. Thus, fluid is spun by these blades for the entire duration that the fluid is in the separation chamber. The additional energy of the elongated circulating blades compensates for the frictional losses incurred as fluid flows against the separation chamber's walls. Finally, exiting fluid may be straightened with straightening vanes (i.e., the rotational component of the fluid is eliminated).

Also, the possibility of excessive fluid flow into and out of the dust collector of the present invention can disrupt fluid flow. This is minimized, however, by strategically placing baffles inside the dust collector.

Further, the present invention can be configured to achieve an arbitrarily high level of separation. To do so, the separation chamber is lengthened as far as is necessary to achieve a specific level of separation. Also, energy losses induced by fluid exchange via fluid passage into the collector can be minimized by narrowing the passage as it nears the outlet of the separation chamber (i.e., tapering the passage). Since particles in the separation chamber become finer as the fluid nears the outlet, appropriate tapering of the passage will not compromise separation. Valves may also be placed at the inlet or outlet of the separator in order to regulate fluid flow. By controlling fluid flow with valves, the efficiency of the separator can be maximized. Moreover, the separator of the present invention is modified such that overall fluid flow travels axially with respect to the rotation of the impeller vanes and circulating blades. Such an axial design allows the separator to be adaptable to a wider range of systems than conventional separators.

An alternative embodiment of the present invention provides a recycle of fluid flow. Thus, fluid may be repeatedly cleaned to effect more complete separation. Implementation of a valve within the recycle tube may be used to control the amount of fluid that is recycled.

Thus, it is an object of the present invention to utilize cylindrical vortices in a dust separator application.

Additionally, it is an object of the present invention to provide an efficient dust separator.

It is a further object of the present invention to provide a lightweight dust separator.

In addition, it is an object of the present invention to provide a low-maintenance dust separator.

It is yet another object of the present invention to provide a bagless dust separator.

It is a further object of the present invention to provide a dust separator that does not require filters.

It is also an object of the present invention to provide non-rotating, substantially dust-free fluid as a product.

Moreover, it is an object of the present invention to provide a dust separator that compensates for frictional losses incurred from fluid flow encountering solid walls or a fluid passage into a dust collector.

Furthermore, it is an object of the present invention to provide a dust separator that is easily modified (via elongation) in order to achieve an arbitrarily high level of dust separation.

Also, it is an object of the present invention to provide a dust separator that minimizes exchange of fluid between the separation chamber and dust collector.

Additionally, it is an object of the present invention to provide an axial flow design to adapt the dust separator for general use.

Furthermore, it is an object of the present invention to recycle fluid flow to effect more complete separation.

Moreover, it is an object of the present invention to smoothly guide fluid flow through a separation system.

These and other objects will become readily apparent to one skilled in the art upon review of the following description, figures, and claims.

### SUMMARY OF THE DRAWINGS

A further understanding of the present invention can be obtained by reference to a preferred embodiment set forth in the illustrations of the accompanying drawings. Although the illustrated embodiment is merely exemplary of systems for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

For a more complete understanding of the present invention, reference is now made to the following drawings in which:

FIGS. 1A and 1B (FIGS. 1A and 1B) depict a side plan view and cross-section thereof, respectively, of an exemplary centrifugal dust separator with a dust collector;

FIGS. 2A and 2B (FIGS. 2A and 2B) depict a side plan view and cross sections thereof, respectively, of an exemplary centrifugal dust separator which compensates for frictional losses with circulating blades;

FIG. 3A (FIG. 3A) depicts a centrifugal dust separator inlet which avoids the motor;

FIG. 3B (FIG. 3B) depicts a centrifugal dust separator which contains its motor in the rotating drum;

FIG. 4 (FIG. 4) depicts a centrifugal dust separator which is elongated to achieve a higher level of dust separation;

FIG. 5 (FIG. 5) depicts modified circulating vanes and rotating drum designed to more smoothly guide fluid flow; and

FIG. 6 (FIG. 6) depicts a centrifugal dust separator which recycles fluid flow.

### DETAILED DESCRIPTION OF THE PREFERRED EMBODIMENTS

As required, a detailed illustrative embodiment of the present invention is disclosed herein. However, techniques, systems and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein which define the scope of the present invention. The following presents a detailed description of a preferred embodiment (as well as some alternative embodiments) of the present invention.

Certain terminology will be used in the following description for convenience in reference only and will not be limiting. The words “in” and “out” will refer to directions toward and away from, respectively, the geometric center of the device and designated and/or reference parts thereof. The words “up” and “down” will indicate directions relative to the horizontal and as depicted in the various figures. Such terminology will include the words above specifically mentioned, derivatives thereof, and words of similar import.

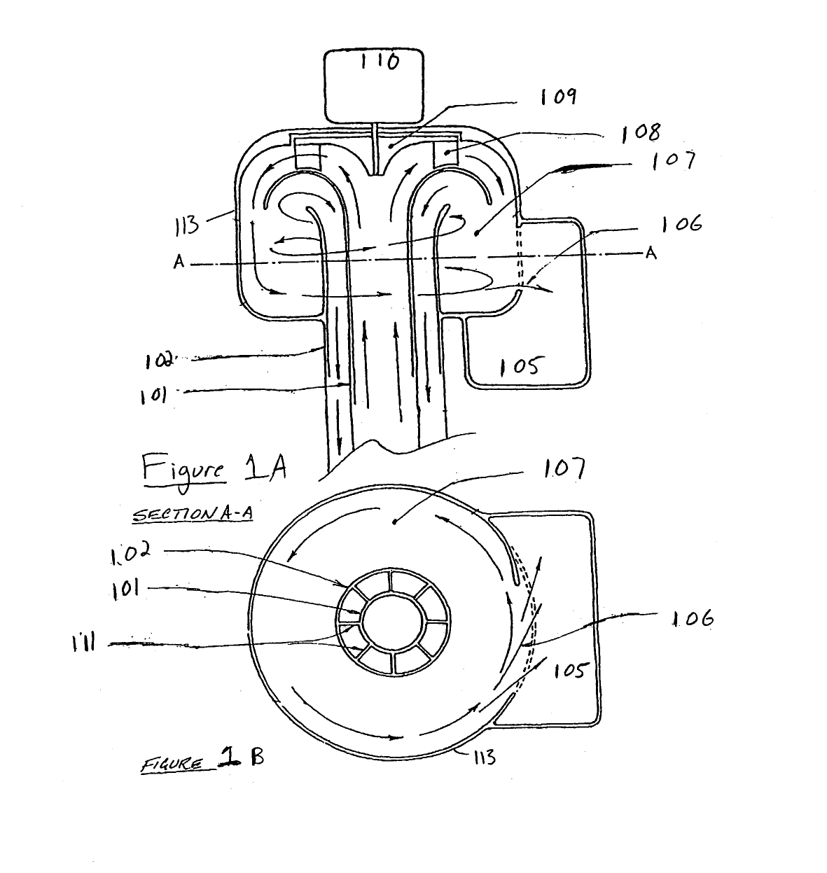

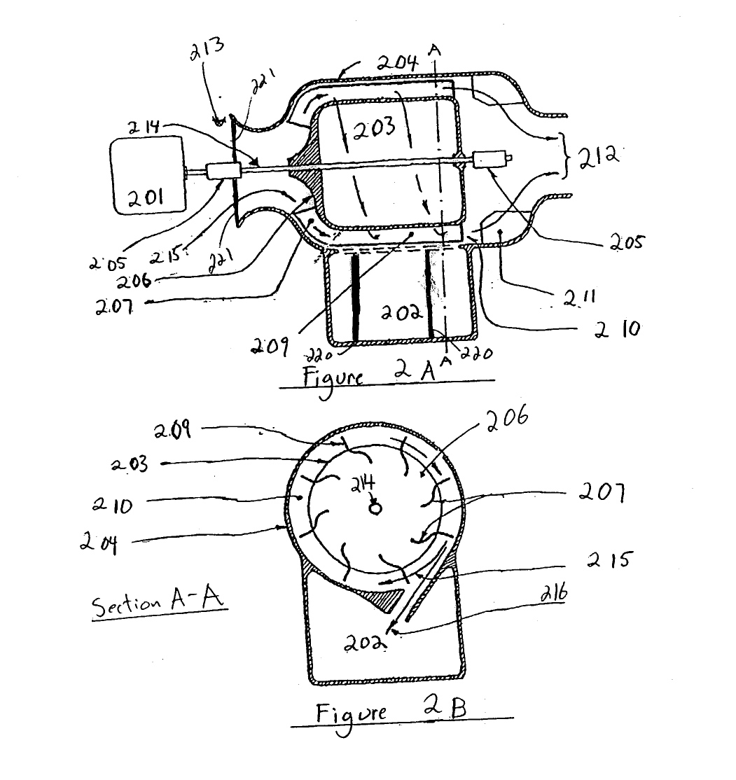

Applicant has disclosed in the parent patent application “Toroidal Vortex Vacuum Cleaner Centrifugal Dust Separator” an improved centrifugal dust separator designed to be used with a toroidal vortex vacuum cleaner. Such a centrifugal dust separator is illustrated in FIG. 1. This centrifugal dust separator advances the art by the addition of a dust collector that uses efficient flow geometry. Here, the dust is collected and stored separately from the cylindrical vortex fluid flow. Further, this separator spins fluid at the high rotational speed of the impeller, which effects efficient separation. Therefore, more complete and reliable separation than possible with conventional separators can occur.

As seen in FIGS. 1A and 1B, at the bottom of the separator are two concentric tubes, the inner tube 101 and the outer tube 102, through which fluid flows. The annular duct created between inner tube 101 and outer tube 102 contains straightening vanes 111. Straightening vanes 111 extend radially outward from the outer wall of inner tube 101 to the inner wall of outer tube 102. Straightening vanes 111 also extend from the top of the annular duct created by inner tube 101 and outer tube 102 downward. The proximal opening of inner tube 101 curves outward to allow for smooth fluid flow. Centered directly above inner tube 101 is impeller 109 comprising impeller blades 108, which are fitted to conform to the curvature in inner tube 101. Motor 110, which provides power to impeller 109, is located above impeller 109. Housing 113 contains impeller blades 108, separation chamber 107, and dust collector 105. Housing 113 connects to the concentric tubing, which is formed by inner tube 101 and outer tube 102, that provides incoming and outgoing fluid flow. The horizontal cross-section depicted in FIG. 1B illustrates the circular shape of housing 113. The cylindrical walls of housing 113 maintain the vortex fluid flow. Attached to the cylindrical portion of housing 113 is dust collector 105. Dust collector 105 is a sealed container in which debris ejected from the vortex accumulate. Housing 113 has an opening in its outer wall through which dust 106 may pass. As shown in the horizontal cross, the edge of the opening facing into the direction of the fluid flow bends slightly inwards to facilitate dust collection. The dust collector 105 is attached to the outer and lower walls of housing 113 as shown in FIG. 1A. The walls of outer tube 102 bend slightly outward to facilitate smooth fluid flow from chamber 107 to the annular exit duct between inner tube 101 and outer tube 102. However, other arrangements to facilitate fluid flow may be used. Inner tube 101 and outer tube 102 may extend downward and terminate with a toroidal vortex nozzle as disclosed in parent applications. Although this is the preferred use, the centrifugal dust separator is capable of functioning without such a nozzle. Any other concentric nozzle design may be used. In addition, any system that supplies an input flow to inner tube 101 and receives an output flow from an annular duct formed between inner tube 101 and outer tube 102 is capable of utilizing the separator.

The flow geometry of the centrifugal dust separator is also depicted in FIGS. 1A and 1B. This embodiment involves dust-laden fluid being sucked up through inner tube 101 under the power of impeller 109. The impeller blades 108 then move the fluid in a circular pattern. Circularly rotating fluid is then directed outwards where it spirals downward along the outer wall of chamber 107 creating a cylindrical vortex flow pattern. The kinetic energy of the circulating fluid creates a higher pressure in dust collector 105 than that of the fluid within the chamber 107. Depending on the system specifications, this pressure may be higher or lower than the outside ambient pressure. This high pressure forces fluid inward, maintaining the fluid's circular path. However, circulating dust 106 is not inhibited from traveling straight into dust collector 105 as shown in FIG. 1. When the spiraling fluid reaches the bottom of the outer wall of chamber 107, the fluid then spirals upward along the inner wall of chamber 107. Remaining dust particles may still travel outward from the inner spiral of fluid. The result is substantially clean fluid exiting the chamber 107 at the top of its inner wall. The cleaned fluid is then sent into the annular duct created between inner tube 101 and outer tube 102, in which it flows downward. With the addition of straightening vanes 111, straight flowing fluid is supplied as a product to a toroidal vortex nozzle or any other desired destination. However, alternative embodiments are possible which do not involve a toroidal vortex nozzle or any nozzle.

The centrifugal separator in FIGS. 1A and 1B has fluid mixed with dirt and dust passing through impeller 109. If such an arrangement is considered undesirable, a trap for large debris may be inserted in the fluid input path upstream of impeller 109. Additionally, the impeller may be replaced with an axial fluid pump or propeller. Such devices may be mounted in inner tube 101. Further, inner tube 101 may be swelled out for this purpose.

The centrifugal dust separator is also capable of functioning in various other fluid media, including water, other liquids, and gases. Moreover, the centrifugal dust separator is capable of separating larger objects from fluid, such as nails, pebbles, sand, screws, etc., in addition to fine particles and dust.

During operation of the aforementioned centrifugal dust separator of FIGS. 1A and lB, frictional losses may slow fluid flow within chamber 107. Frictional losses are induced by fluid flow interacting with the walls of chamber 107 and fluid flow entering and exiting dust collector 105. Nevertheless, the centrifugal separator of the present invention compensates for such frictional losses with the addition of circulating blades, strategically placed baffles, and a specially designed passage into the dust collector.

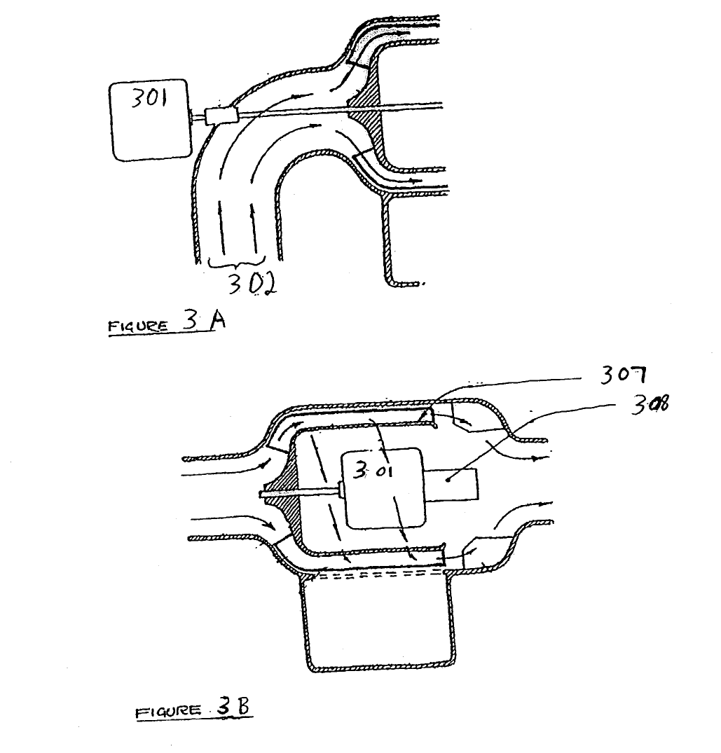

The first embodiment of the present invention is depicted in FIGS. 2A and 2B. As shown in FIG. 2A, fluid is impelled at inlet 213 on one side of the separator and expelled out outlet 212 on the other side. One major difference from the separator of FIG. 1 lies in the positioning of inlet 213 and outlet 212. Collector 202, similar to that which is depicted in FIG. 1, is contained within outer casing 204. Also within outer casing 204 is rotating drum 203. Rotating drum 203 is coupled to driveshaft 214 which is powered by motor 201. Motor 201 may be fixed to outer casing 204 via bracket members 221. Driveshaft 214 may be equipped with shaft bearings 205 to reduce friction and stabilize driveshaft 214 during rotation. Coupled to the outside of rotating drum 203 are impeller blades 207 and circulating blades 209. Impeller blades 207 are preferably constructed with a reverse curve which more smoothly guides fluid to circulating blades 209. Just before outlet 212, flow straightening vanes 211 are installed to remove the rotational component from exiting fluid.

Cylindrical design of separation chamber 210 is illustrated in FIG. 2B. The improved centrifugal dust separator operates by impelling fluid with impeller 206. Impeller blades 207 spin fluid at the high speed at which they rotate. The rotating fluid then forms a cylindrical vortex fluid flow pattern in separation chamber 210. Higher mass dust particles 216 are centrifugally separated and ejected in collector 202. The movement of the rotating fluid increases the pressure in collector 202 since fluid flow 215 exerts an outward force ρRV². Here, ρ=fluid density; R=radius of rotation; and V=fluid's velocity close to the wall. This high pressure creates, in equilibrium, an inward force of equal magnitude maintaining cylindrical fluid flow 215 without inhibiting smaller dust particles from flowing into collector 202. Dust flow 216 is shown in FIG. 2B.

The dust collection in the present invention does not depend on the amount of dust in collector 202, as in conventional systems where dust collection deteriorates as dust accumulates. Moreover, the separator of the present invention is capable of collecting various other matter such as sand, screws, dirt, nails, bolts, and other objects.

Fluid travels further from inlet 213, however, frictional losses are incurred as fluid flow travels along the outer wall of the separation chamber 210. Such frictional losses occur any time fluid flows along a solid surface. Further frictional losses result from fluid exchange between separation chamber 210 and collector 202. To minimize the friction of fluid flowing along the outer wall of separation chamber 210, the wall preferably ahs a highly polished finish. To further compensate for the frictional losses, rotating drum 203 rotates circulating blades 209. Circulating blades 209 continue to spin fluid for the entire length of separation chamber 210, thereby replacing kinetic energy lost to friction. Spinning the fluid at a constant velocity for the entire length of separation chamber 210 results in a constant pressure along the entire length of the collector 202. Without the additional circulating blades 209, the pressure would gradually decrease as the fluid flow slows due to friction and as a consequence there would be a fluid flow along collector 202 that could allow dust and debris to reenter separation chamber 210 further upstream. Thus, the action of circulating blades 209 results in more thorough separation by maintaining the velocity of spinning fluid flow.

In order to minimize the fluid exchange between separation chamber 210 and collector 202, baffles 202 (which are in this case vertical) can be implemented strategically to divide collector 202 into sections. These baffles minimize fluid circulation across collector 202.

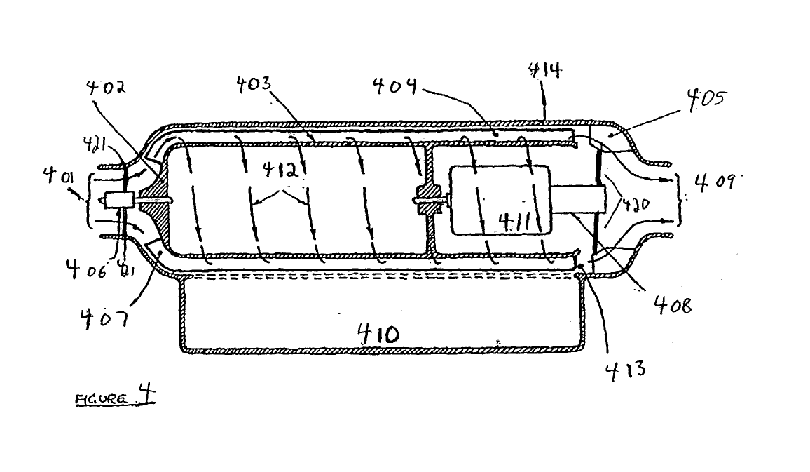

The separator can be modified to prevent the motor from obstructing incoming fluid. Two such modifications are depicted in FIGS. 3A and 3B. FIG. 3A shows extended inlet 302 which is bent to avoid motor 301. FIG. 3B shows an embodiment in which motor 301 is mounted on motor mount 308 inside rotating drum 307. Motor mount 308 may be supported by attaching it (via radial members) to the housing. Thus, flowing fluid does not interact with the motor 301.

The separator may be further modified to achieve higher levels of dust separation. To do so, the separator can be elongated axially as shown in FIG. 4. Since the basic design of the separator is the same, the separator can be constructed arbitrarily long to achieve any desired level of separation. Inlet 401, shaft bearings 406, bracket members 421, impeller 402, impeller blades 407, flow straightening vanes 405, and outlet 409 remain as disclosed in previous embodiments of the present invention. Separation chamber 413 is elongated to extend the amount of time fluid spends in separation chamber 413. Therefore, the number of times the fluid circulates within separation chamber 413 is also increased. Consequently, light and fine dust particles have more time to migrate to the outer wall of separation chamber 413 and be ejected into collector 410. Likewise, collector 410, circulating blades 404, rotating drum 403, and outer casing 414 are also elongated. Thus, the fluid flow's high rotational speed is maintained throughout separation chamber 413. Motor 411 is mounted on motor mount 408 inside rotating drum 403. Motor mount 409 may be fixed to flow straightening vanes 405 via bracket members 420.

As the fluid flow nears outlet 409, the remaining particles in circulating fluid flow 412 decrease in size. Additionally, the necessary width of the passage into collector 410 decreases as the size of the dust particles decrease. Therefore, the passage into collector 410 preferably narrows as it nears the outlet. The narrower passage minimizes fluid exchange between separation chamber 413 and collector 410. Thus, the energy losses caused by such fluid exchange can also be minimized.

The efficiency of separating fine particles from fluid flow depends on the length of time it takes the particles to drift to the outer wall of separation chamber 413. By metering the rate of fluid flow through the separation system, the operation may be optimized to capture the most dust particles. Valves may be placed at either fluid inlet 401 or fluid outlet 409 in order to meter the rate of fluid flow through the system.

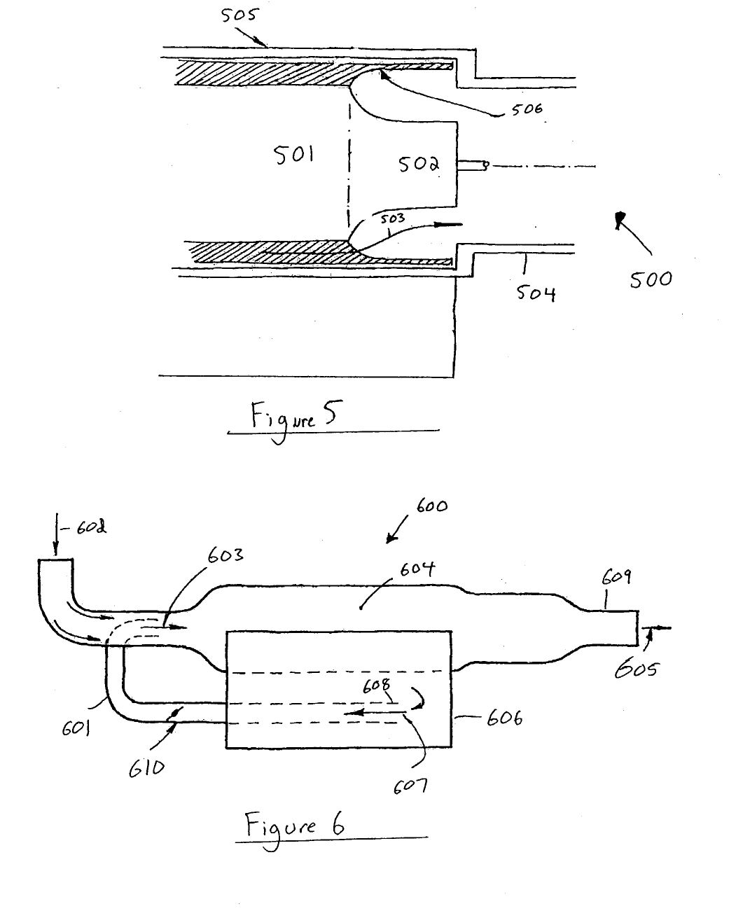

The outlet of the present invention can be configured to more smoothly guide fluid flow. To achieve this, FIG. 5 depicts modified outlet 500 of an axial flow centrifugal separator in accordance with the present invention. Rotating drum 501 comprises tapered end 502 which smoothly guides fluid flow 503 to outlet tube 504. Because dust and debris remain close to wall 505 during the end of separation, circulating blades 506 may be tapered as shown. Thus, separation can continue without being compromised while fluid flow 503 passes through the tapered section of circulating blades 506 while minimizing disturbance of exiting fluid flow 503. Consequently, flow dynamics are optimized.

In some instances (i.e., when there is a space constraint limiting the size of the separator), a single pass through an axial flow separator may not be suffice for achieving the desired level of separation. In such situations, recycle tube 601 may be fitted to axial flow centrifugal separator 600 of FIG. 6. Here, dirty fluid flow 602 enters the system and mixes with recycled fluid flow 603. The mixed fluid flow continues through separation chamber 604 as described supra. Cleaned fluid flow 605 exits the system from outlet 609, but some fluid flow will pass into collector 606. Once in collector 606, fluid flow 607 may pass into inlet 608 of recycle tube 601. Preferably, inlet 608 is as close to outlet 609 as possible while centered within the vertical cross-section of collector 606. This positioning ensures that the only the cleanest fluid enters inlet 608 because dust and debris tend to circulate around the outer walls of collector 606 or settle to the bottom of collector 606. Furthermore, the pressure within collector 606 must be maintained higher than the pressure of dirty fluid flow 602 in order to prevent fluid from flowing in the reverse direction in recycle tube 601. Additionally, valve 610 may be implemented in recycle tube 601 to control the amount of fluid flow that is recycled.

While the present invention has been described with reference to one or more preferred embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention.

I claim:

1. An apparatus for centrifugally separating matter from a fluid comprising:
fluid delivery means for moving fluid through said apparatus;
at least one cylindrical outer casing;
at least one separation chamber contained within said cylindrical outer casing; and
at least one circulating blade;
wherein said matter is separated centrifugally from said fluid by a fluid flow created by at least one of said fluid delivery means or said plurality of circulating blades.

2. An apparatus according to claim 1, wherein said fluid flow forms a cylindrical vortex.

3. An apparatus according to claim 1, wherein said circulating blade rotates on a rotating drum.

4. An apparatus according to claim 1, wherein said fluid delivery means comprises an impeller.

5. An apparatus according to claim 4, wherein said impeller comprises at least one curved vane.

6. An apparatus according to claim 5, wherein said curved vane is shaped having a reverse curve.

7. An apparatus according to claim 1 further comprising a collector wherein the passage leading into said collector is tapered such that said passage is substantially narrower at the exit of said apparatus.

8. An apparatus according to claim 1, wherein said fluid exits said apparatus on the opposite side that said fluid enters said apparatus such that the overall fluid flow is axial with respect to rotation of said circulating blade.

9. An apparatus according to claim 1 further comprising at least one straightening vane.

10. An apparatus according to claim 1 further comprising a motor to power at least one of said fluid delivery means or said circulating blade.

11. An apparatus according to claim 1 further comprising a driveshaft to transfer power to said circulating blade.

12. An apparatus according to claim 1, wherein said fluid delivery means comprises at least one impeller blade which is connected to said circulating blade.

13. An apparatus according to claim 1 that can be constructed such that the axial length of said apparatus, with respect to the rotation of said circulating blade, can be arbitrarily large to effect a desired level of separation of said matter from said fluid.

14. An apparatus according to claim 1 further comprising tubing serving as a fluid inlet.

15. An apparatus according to claim 1 further comprising a collector.

16. An apparatus according to claim 15, wherein said fluid flow creates a higher pressure in said collector than in said separation chamber wherein said higher pressure can maintain a cylindrical vortex fluid flow in said separation chamber without inhibiting said matter from traveling into said collector.

17. An apparatus according to claim 1 further comprising:
at least one rotating drum;
at least one collector;
at least one driveshaft; and
at least one cylindrical outer casing;
wherein said apparatus can be constructed such that at least one of said rotating drum, said driveshaft, said cylindrical outer casing, said collector, or said plurality of circulating blades is arbitrarily long to effect a desired level of separation of said matter from said fluid.

18. An apparatus according to claim 1 further comprising:
at least one fluid inlet;
at least one fluid outlet; and
at least one valve;
wherein at least one of said fluid inlet or said fluid outlet utilizes said valve to meter said fluid flow.

19. An apparatus according to claim 1 further comprising at least one recycle tube which transports fluid flow that is at least partially cleaned to mix with fluid flow that is substantially less clean.

20. An apparatus according to claim 19 further comprising a collector from which said recycle tube transports said fluid flow.

21. An apparatus according to claim 20, wherein said recycle tube is coupled to the collector at the end further downstream relative to said fluid flow proximally at the middle of a cross-section of said collector.

22. An apparatus according to claim 19, wherein said recycle tube comprises at least one valve.

23. An apparatus according to claim 1, wherein said circulating blade is tapered to smoothly guide fluid flow.

24. An apparatus according to claim 1 further comprising a rotating drum, said rotating drum being tapered to smoothly guide fluid flow.

25. An apparatus for centrifugally separating matter from a fluid comprising:
at least one cylindrical outer casing;
at least one separation chamber contained within said cylindrical outer casing; and
at least one circulating blade;
wherein said matter is separated from said fluid by a fluid flow created by said circulating blade.

26. An apparatus according to claim 25, wherein said fluid flow forms a cylindrical vortex.

27. An apparatus according to claim 25, wherein said circulating blade rotates on a rotating drum.

28. An apparatus according to claim 25, wherein said fluid exits said apparatus on the opposite side that said fluid enters said apparatus such that the overall fluid flow is axial with respect to rotation of said circulating blade.

29. An apparatus according to claim 25 further comprising at least one straightening vane.

30. An apparatus according to claim 25 further comprising a motor to power said circulating blade.

31. An apparatus according to claim 25 further comprising a driveshaft to transfer power to said circulating blade.

32. An apparatus according to claim 25 that can be constructed such that the axial length of said apparatus, with respect to the rotation of said circulating blade, can be arbitrarily large to effect more complete separation of said matter from said fluid.

33. An apparatus according to claim 25 further comprising tubing serving as a fluid inlet.

34. An apparatus according to claim 25 further comprising a collector.

35. An apparatus according to claim 34 further comprising a collector to collect said matter, wherein said fluid flow creates a higher pressure in said collector than in said separation chamber wherein said higher pressure can maintain a cylindrical vortex fluid flow in said separation chamber without inhibiting said matter from traveling into said collector.

36. An apparatus according to claim 25 further comprising:
at least one rotating drum;
at least one collector;
at least one driveshaft; and
a cylindrical outer casing;
wherein said apparatus can be constructed such that at least one of said rotating drum, said driveshaft, said cylindrical outer casing, said collector, or said circulating blade is arbitrarily long to effect a desired level of separation of said matter from said fluid.

37. An apparatus according to claim 35, wherein the passage leading from said separation chamber to said collector is tapered such that said passage is substantially narrower at the exit of said apparatus.

38. An apparatus according to claim 25 further comprising:
at least one fluid inlet;
at least one fluid outlet; and
at least one valve;
wherein at least one of said fluid inlet or said fluid outlet utilizes said valve to meter said fluid flow.

39. An apparatus according to claim 25 further comprising at least one recycle tube which transports fluid flow that is at least partially cleaned to mix with fluid flow that is substantially less clean.

40. An apparatus according to claim 39, wherein said recycle tube transports said fluid flow from said collector.

41. An apparatus according to claim 40, wherein said recycle tube is coupled to the collector at the end further downstream relative to said fluid flow proximally at the middle of a cross-section of said collector.

42. An apparatus according to claim 39, wherein said recycle tube comprises at least one valve.

43. An apparatus according to claim 25, wherein said circulating blade is tapered to smoothly guide fluid flow.

44. An apparatus according to claim 25, wherein said rotating drum is tapered to smoothly guide fluid flow.

45. A method of centrifugally separating matter from a fluid comprising the steps of:
creating a cylindrical vortex fluid flow within a cylindrical outer casing; and
maintaining said cylindrical vortex fluid flow with at least one circulating blade.

46. A method according to claim 45 further comprising the step of straightening said fluid flow to remove rotational components of said fluid flow.

47. A method according to claim 45 further comprising the step of metering said fluid flow with at least one valve.

48. A method according to claim 45 further comprising the step of ejecting said matter into a collector.

49. A method according to claim 48, wherein the pressure in said collector is greater than the pressure in said cylindrical vortex such that said cylindrical vortex fluid flow is maintained without impeding said matter from traveling into said collector.

50. A method according to claim 45 further comprising the step of recycling said fluid flow that is at least partially cleaned to mix with said fluid flow that is substantially less cleaned.
